(19) United States
(12) Patent Application Publication
(10) Pub. No.: US 2004/0044783 A1
(43) Pub. Date: Mar. 4, 2004

(54) Method and arrangement for tuning rate of media stream

(76) Inventor: Marko Nordberg, Helsinki (FI)

Correspondence Address: SALTAMAR INNOVATIONS, 30 FERN LANE, SOUTH PORTLAND, ME, 04106, US

(21) Appl. No.: 10/279,624

(22) Filed: Oct. 24, 2002

(30) Foreign Application Priority Data
Aug. 27, 2002 (FI) 20021527

(51) Int. Cl. G06F 15/16

(52) U.S. Cl. 709/231; 709/232

(57) ABSTRACT

This invention relates to tuning of the rate of a media stream, in particular the playback speed. The playback speed (i.e. the rate) of the presentation (such as video and audio) is adjusted. It gives a needed fine tune control for streaming the show, especially in a wireless environment. The rate of a presentation, usually video, compressed for a predefined bandwidth is kept, but the playback is at a lower data rate, reflecting the actual transmission rate in the network.

### FIELD OF THE INVENTION

This invention relates to tuning the rate of a media stream. Further, the invention relates to media streams in a communication network, and particularly media streams in a wireless network. The media streams may, for example, be video, audio, or other presentations (like animation data) sent over the network.

### BACKGROUND OF THE INVENTION

When a media (audio, video, text, etc.) is streamed from a server to a receiving terminal in a communication network, a constant average bandwidth is usually anticipated. Videos (and other media) are compressed with suitable assumptions on what could be the expected data transmission rate. For example, users with a modem connection may expect to receive a data rate of 40 kbps (kilobits per second), and users with a home ADSL connection may expect to receive 200 kbps on average. Thus, videos should be compressed for both cases, specifying an average data rate of 40 kbps and 200 kbps.

However, even with the normal rate of 200 kbps congestion and data errors may occur in the network, and the available data rate decreases. Choosing a video bandwidth close to the maximum value, i.e. close to the maximum transmission rate, gives better video or audio quality. However, there is a risk that in a congested network a transmission rate may drop, and the video may not be delivered properly.

There exist solutions to select and control the transmission rate of a streaming media for matching the amount of transmitted data to an available network condition, i.e. an available bandwidth. For example, several different methods handle a number of data transmission rates in changing network situations. Some of them are client-based only solutions, and some are client-server solutions based on cooperation between the receiver and transmitter parts.

A client terminal may measure the rate of incoming data and buffer enough data at the beginning of the playback of the media stream so that the rest of the stream can be streamed without interruptions. Thus reliance on servers is not needed. A drawback of this method is that the buffering time may become very long. Also network conditions may change during the streaming. The buffering is simple to implement, but requires a lot of memory. A client may accept some interruptions in a video presentation. In this case, only a part of the video, is buffered at the beginning of the transmission. The start of the transmission is faster, but the transmission of the video is interrupted later for additional buffering.

Another way is that a client terminal measures the transmission rate and chooses one of several precompressed video versions, which suits best for the connection. This is a commonly used and suitable method, when there are large differences in rates, such as 40 and 200 kbps. Some additional buffering may also be needed, if the connection slows down over the period the streamed presentation takes. Precompressed videos save processing power, but only a limited number of data rates can be offered, and they consume much disk space.

A problem with the above is that speed differences in precompressed video data rates are usually large, for example 40 kbps, 80 kbps, and 200 kbps. When the data rate is changed, a user normally experiences an inconvenient, disturbing and dramatic change in the video and audio quality. Also, if the available average data rate would be 190 kbps, it is unnecessary to go as low as 80 kbps. The compression could be made for the 190 kbps stream, but it takes a lot of computing power and/or storage space to make the recompression for each possible usage situation. Serving several users would need a large specialized hardware array.

In real-time solutions, control protocols need two-way communications. Transcoders usually need expensive hardware. They also may offer only a limited selection of available compression rates. These weaknesses are especially true when a wireless data service, such as the GPRS, is used for streaming. Wireless networks have very long round trip times. Sending a request and getting a response may take several seconds. For this reason, control protocols are usually too slow for adapting to data rate changes. Additionally, wireless terminal devices don't have large memories, so enough buffer space may not be available.

Experience has shown that 26 kbps is a good estimation for an average GPRS throughput in some networks. So under these conditions, it is reasonable to precompress videos for this data rate.

All known solutions use some combination of buffering, bandwidth selection, client feedback, and server support. However, transcoders are very rare, when a video is simultaneously streamed for a large number of clients.

Let's say that the average rate of 26 kbps occasionally drops to 25 kbps. On a 10-minute video this would require 75 kilobytes of additional buffer memory and 24 seconds of buffering time. The control protocol may be too slow to react because of the round trip time; precompressed videos may not have a suitable choice for the new data rate. As can be noted, the known solutions are clumsy and may interrupt the playback of a streaming media. The aim of this invention is to alleviate the above-mentioned problems.

### SUMMARY OF THE INVENTION

An underlying principle of the invention is that by adjusting the playback speed (i.e. the rate) of the presentation (such as video and audio), it gives a needed fine tune control for streaming the show, especially in a wireless environment. In the inventive solution, the rate of a presentation, usually video, compressed for a predefined bandwidth is kept, but the playback is at a lower data rate, reflecting the actual transmission rate in the network. Naturally, this changes the speed and duration of the presentation on the display, but humans are not sensitive to small changes in a video playback speed. Even changes of 10% or more may be tolerated. For example, as illustrated in FIG. 1 when a conversion 1 from the normal 24 images per second movie format 2 to the PAL video format 3 is made, there is a 4% change in the presentation speed, but the audience is not able to notice it.

The human ear is more sensitive to pitch changes in audio. Any implementation according to the invention may either accept this, or it may use one of many known algorithms for changing the audio speed, while keeping the original pitch. The method according to the invention is especially suitable on wireless networks and mobile devices, where network characteristics and device limitations put restrictions on the use of earlier know methods.

The inventive method controls the transmission rate of a streaming media wherein the transmission rate is tuned to be as optimal as possible. The method comprises at least the steps of: measuring the transmission rate; adjusting the playback rate of the streaming media according to the transmission rate measurement; and tuning the transmission rate according to the transmission rate measurement if the adjusting step is not sufficient. Naturally, the adjusting step affects the tuning of the transmission rate as well.

An arrangement according to the invention controls the transmission rate of a streaming media wherein the transmission rate is tuned to be as optimal as possible. The arrangement comprises at least: measuring means for measuring a transmission rate; first control means for controlling the playback time of the streaming media according to the transmission rate measurement; and second control means for tuning the transmission rate according to the transmission rate measurement if the adjusting step fails to be a sufficient action.

### BRIEF DESCRIPTION OF THE DRAWINGS

In the following the invention is described in more detail by the aid of the attached drawings where

FIG. 1 illustrates an example of the conversion from a movie format to a PAL format,

FIG. 2 illustrates an example of elements in a receiving terminal,

FIG. 3 illustrates an example of a receiving buffer,

FIG. 4 illustrates an example of the comparison between a known arrangement and an inventive arrangement,

FIG. 5 illustrates an example of an arrangement according to the invention, and

FIG. 6 illustrates an example of a flow chart describing the inventive method.

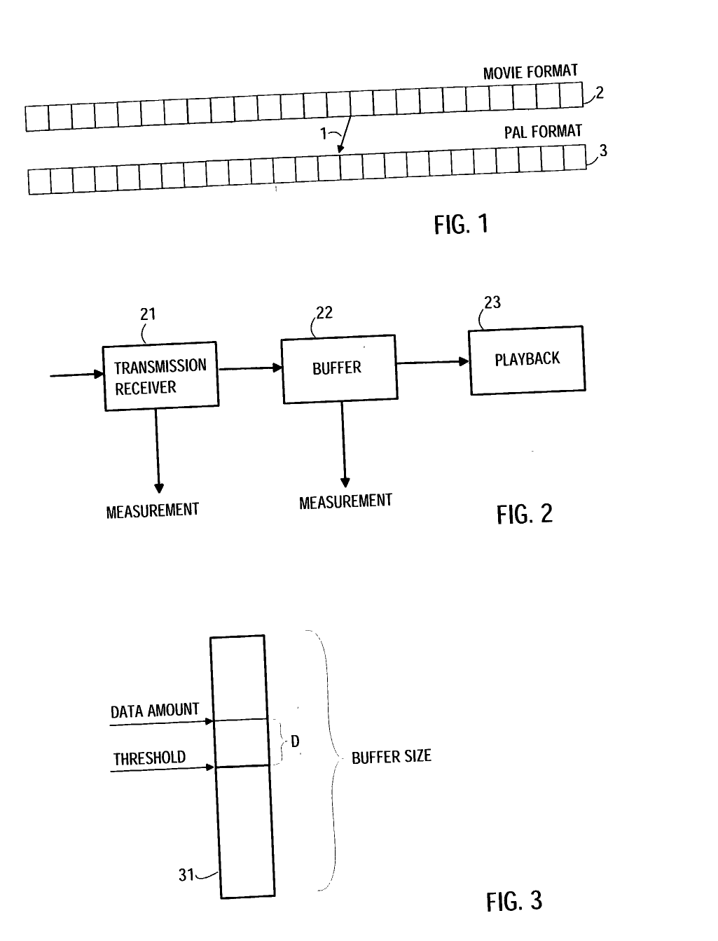

### DETAILED DESCRIPTION OF THE INVENTION

FIG. 2 shows an example of elements in a receiving terminal. The receiving terminal comprises a receiver 21 for receiving streaming media. The terminal also comprises a buffer 22 for creating certainty and for balancing the transmission and the playback of the streaming media against changes of the transmission rate. And naturally, the terminal comprises the playback module 23. As can be seen, it is possible to measure the transmission rate in the receiver or in the buffer. The measurement in the buffer can be made, for example, by measuring the amount of the received data. This can be done by calculating the number, size, and/or times of the received data packets. Further, another way is to calculate how fast the receiving buffer is emptying, for example measuring the rate of change of the data amount in the buffer for the need of adjustment. The measurement in the receiver module directly calculates the amount of received data per period. Normally, the client terminal measures the transmission rate continuously during the streaming of data, such as a video show.

A usual situation is that a client terminal detects that the transmission rate is not high enough for the video show, i.e. the bandwidth of the video. In this case, the terminal, according to the invention, adjusts the playback speed to be lower. The adjustment may have a maximum limit, for example, 10% from the reference playback speed. Naturally, the transmission rate may also be too fast for the video show, when the terminal adjusts the playback rate to be higher. The adjustment can be preferably filtered (i.e., dampened) using a filter module to prevent disturbing changes in playback speed, which could be visible to the user.

If the amount of the data in the stream is known, the client terminal may calculate, when the receiving buffer contains sufficient data for the uninterrupted playback, and adapt the adjustment—meaning the adjustment of the playback rate and/or tuning the transmission rate. In this case, the adjustment may be stopped before the end of the presentation, or an adjusting algorithm or parameters may be changed. Any known methods for calculating the amount of data needed for the buffering can be used. This calculation may take into account the knowledge that the playback speed can be adjusted.

If the playback adjustment is not enough, the client may revert to any previously known method for selecting a more suitable streaming source. The playback adjustment can be used again with this new source. In other words, the transmission rate is tuned according to the transmission rate measurement, if the playback adjustment fails to be a sufficient action.

FIG. 3 shows an example of a receiving buffer 31. The next example, referring to FIG. 3, describes a way for calculating a playback adjustment value, which indicates how much the playback speed may be slowed down:

Bₛ Size of the streaming buffer,

Bₐ Amount of data in the streaming buffer,

Bₜ Buffer threshold. The maximum adjustment is made when Bₐ falls below it,

Aₙ Adjustment value 0 . . . 1,

f Filter value 0 . . . 1,

Pₘₐₓ Maximum adjustment in percents,

P Adjustment to be done in percents,

A₀=0

Aₙ=(1−((Bₐ−Bₜ)/Bₛ))*(1−f)+Aₙ₋₁* f

Aₙ=0, if Aₙ<0; 1, if Aₙ>1; Aₙ otherwise

P=Aₙ* Pₘₐₓ

As can be seen from the above formula, the difference D between the threshold value Bₜ and the data amount in the buffer Bₐ in relation to the buffer size Bₛ affects the adjustment value. When D increases (the data amount increases in the buffer), the slow down adjustment becomes smaller. When D decreases (the data amount decreases in the buffer), the slow down adjustment becomes greater. Although, the threshold is situated at the middle of the buffer in FIG. 3, it can be set to any desired level.

The above example is just an example of one formula that could be used for the calculation. Other methods may, for example, use a PID (Proportional-Integral-Differential)-controller, where the playback rate is the value to be adjusted, and the network transmission rate or the amount of data in the receiving buffer is the measured value. Choosing suitable parameters for the PID-controller will give a suitable transition character, which has a proper feedback and which doesn't vibrate. PID is merely an example; other controlling methods may also be used.

The above method may also be used for variable bit rate streaming sources, not only constant bit rate sources. In this case, using the amount of data in the receiving buffer would be more appropriate, since it also takes into account the speed at which the data is consumed.

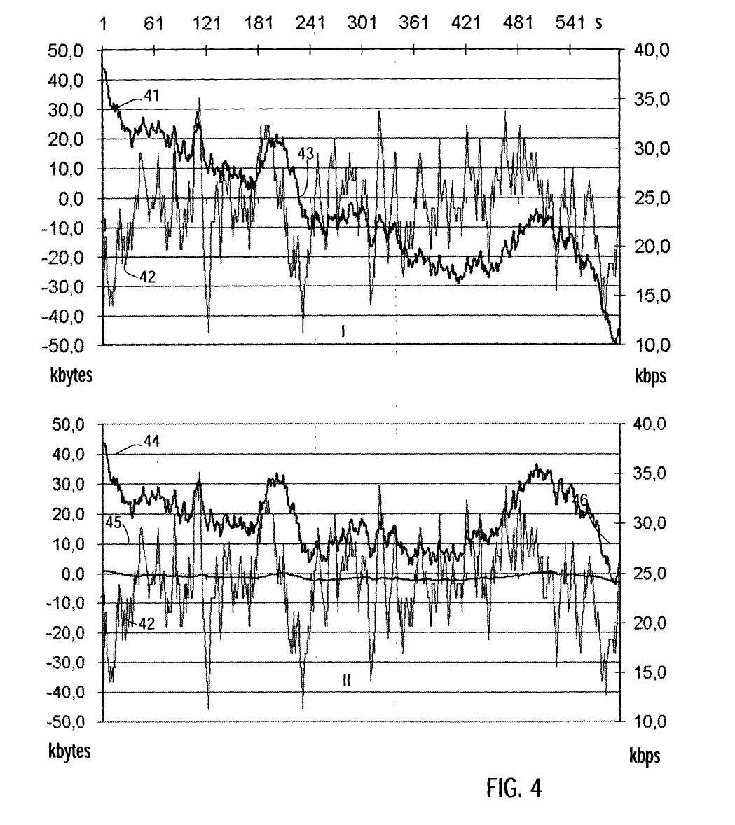

FIG. 4 illustrates an example of the comparison between a known arrangement and an inventive arrangement. Graph 1 shows the data relationships in a known arrangement, where line 41 describes a needed buffer size at a time, and line 42 the transmission rate at a time. The playback rate is constant. The left scale is for the buffer size, the right scale for the transmission rate, and the upper scale is a time axis in seconds. At moment 43, the needed buffer size becomes negative, i.e. the buffer becomes empty. This means that the buffer does not balance the playing of the streaming presentation any more, and the playback is interrupted. It should be noted that the FIG. 4 represents a simulation of the transmission of the video show of ten minutes. The transmission rate is based on an empirical data from real situations. Since the simulation is in question, negative buffer size values are possible (The null level may be fixed to any buffer size level.). The positive values represent real values needed in the real buffer, which size is 45 Kbytes. However, if no interruptions are required, the buffer size should be 94 Kbytes, i.e. 45+50 Kbytes, as FIG. 4 shows.

Sheet II shows an example data relationship in a device operating in accordance with the invention, where line 44 describes a needed buffer size at a time, and line 42 the transmission rate at a time. Line 45 describes the playback rate as a percentage at a time from the average playback rate. The scales are the same as in sheet 1. As can be seen, not until moment 46 does the needed buffer becomes negative. The difference between moments 43 and 46 is 365 seconds i.e. over 6 minutes. As can be noted, the invention remarkably improves the performance of the system for playing streaming shows.

The difference between moment 43 and 48 in sheets I and II is about 155 seconds according to the time scale. This indicates that the inventive arrangement is much more reliable than the know solutions and alleviates problems associated therewith.

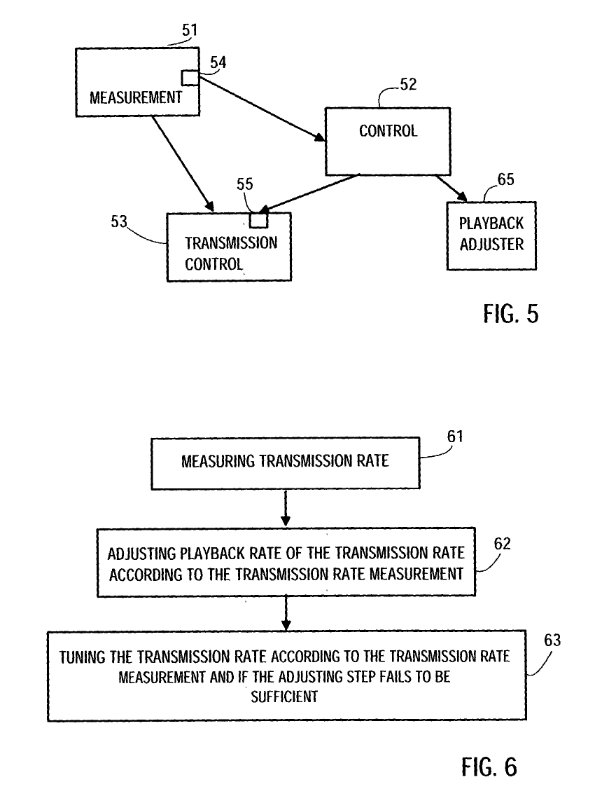

FIG. 5 illustrates an example of an arrangement according to the invention. The measurement module 51 measures the transmission rate (or corresponding information), which the control module 52 uses for controlling the playback rate. If the control of the playback is insufficient, the transmission control module 53 in the receiver handles the tuning of the transmission rate. It should be noted that the transmission control module preferably works together with the sending terminal.

The measurement module preferably also comprises an interface 54 for a connection to the control module 52. The transmission control module preferably comprises an interface 55 for receiving information about the success of the control module. Naturally, the arrangement comprises playback adjuster module 65.

FIG. 6 illustrates an example of a flow chart describing an aspect of the inventive method. First, the transmission rate is measured 61. Then the playback rate of the streaming media is adjusted 62 according to the transmission rate measurement. If the adjusting step isn't sufficient, the transmission rate is tuned 63 according to the transmission rate measurement.

The invention makes it possible to make a video player on a mobile terminal with a GPRS connection and using a video-on-demand service. Further, the invention offers a smooth and pleasant video experience with as little buffering as possible. There are no sudden quality changes due to reselecting a new compressed video data rate in the middle of the presentation, and the video player does not frequently stop for rebuffering.

Although, the invention is described in a few examples in this text, it is clear that the invention is not restricted to them. Thus, it is evident that the invention can be used in many other, solutions, in the scope of the inventive idea.

1. A method for controlling a transmission rate of a streaming media wherein the transmission rate is tuned, the method comprising the steps of
measuring the transmission rate,
adjusting a playback rate of the streaming media according to the transmission rate measurement, and
controlling the tuning of the transmission rate according to the transmission rate measurement if the adjusting step fails to be sufficient.

2. A method according to claim 1, wherein the transmission rate measurement is made in a buffer.

3. A method according to claim 1, wherein the transmission rate measurement is made in a transmission receiver.

4. A method according to claim 2, wherein the playback rate is adjusted to be higher if the data amount increases in the buffer, and wherein the playback rate is adjusted to be lower if the data amount decreases in the buffer,

5. A method according to claim 3, wherein the playback rate is adjusted to be higher if the data amount increases in the buffer, and wherein the playback rate is adjusted to be lower if the data amount decreases in the buffer,

6. A method according to claim 4, wherein the playback adjustment is made according to the decrease or increase in proportion to a buffer size.

7. A method according to claim 4, wherein the playback adjustment is made according to a rate of change of the data amount within the buffer.

8. A method according to claim 4, wherein if the data amount of the streaming media is known, the adjustment is modified when the buffer contains sufficient data for playing the streaming media to the end.

9. A method according to claim 4, wherein the adjustment is dampened for preventing disturbing changes in the playback rate.

10. A method according to claim 5, wherein the adjustment is filtered for preventing disturbing changes in the playback rate.

11. A method according to claim 6, wherein the adjustment is dampened for preventing disturbing changes in the playback rate.

12. A method according to claim 7, wherein the adjustment is dampened for preventing disturbing changes in the playback rate.

13. A method according to claim 8, wherein the adjustment is dampened for preventing disturbing changes in the playback rate.

14. An arrangement for controlling a transmission rate of a streaming media wherein the transmission rate is tuned, wherein the arrangement comprises:
a measurement module for measuring a transmission rate,
a control module for controlling a playback time of the streaming media according to the transmission rate measurement, and
a transmission control module for controlling the tuning of the transmission rate according to the transmission rate measurement and if the adjusting step fails to be sufficient.

15. An arrangement according to claim 14, wherein the measurement module comprises a buffer.

16. An arrangement according to claim 14, wherein the measurement module comprises a transmission receiver

17. An arrangement according to claim 14, measurement module comprises an interface for the control module.

18. An arrangement according to claim 14, wherein the transmission control module comprises an interface for the control module.

19. An arrangement according to claim 14, wherein the arrangement comprises a playback adjuster.

20. An arrangement according to claim 10, wherein the arrangement comprises a filter for filtering the control of the playback rate.

21. An arrangement according to claim 15, characterized in that the measuring means comprises an interface for the first control means.

22. An arrangement according to claim 16, characterized in that the measuring means comprises an interface for the first control means.

23. An arrangement according to claim 17, characterized in that the second control means comprises an interface for the first control means.

24. An arrangement according to claim 18, characterized in that the arrangement comprises a playback adjuster.

25. An arrangement according to claim 16, characterized in that the arrangement comprises a filter for filtering the control of the playback rate.

26. An arrangement according to claim 19, characterized in that the arrangement comprises a filter for filtering the control of the playback rate.
